(19) United States
(12) Patent Application Publication
(10) Pub. No.: US 2025/0088239 A1
(43) Pub. Date: Mar. 13, 2025

(54) CHANNEL CALCULATIONS BASED ON CHANNEL STATE INFORMATION REFERENCE SIGNAL (CSI-RS) AND SOUNDING REFERENCE SIGNAL (SRS)

(71) Applicant: QUALCOMM Incorporated, San Diego, CA (US)

(72) Inventors: Runxin WANG, San Diego, CA (US); Yu ZHANG, San Diego, CA (US); Jay Kumar SUNDARARAJAN, San Diego, CA (US); Taesang YOO, San Diego, CA (US)

(21) Appl. No.: 18/244,871

(22) Filed: Sep. 11, 2023

(51) Int. Cl. H04B 7/06

(52) U.S. Cl. CPC H04B 7/0626; H04B 7/06966; H04B 7/06968

(57) ABSTRACT

Certain aspects of the present disclosure provide techniques for wireless communications by an apparatus. A method includes sending signaling indicative of one or more power ratios, wherein each of the one or more power ratios is based on a transmit power for transmitting sounding reference signal (SRS) using a corresponding antenna and a receive power for receiving channel state information reference signal (CSI-RS) using the corresponding antenna, and wherein the one or more power ratios are associated with one or more antennas; sending a first CSI-RS; receiving a first SRS; receiving first channel state feedback (CSF) corresponding to the CSI-RS; and performing channel estimation based on the first CSF and the first SRS.

### INTRODUCTION

### Field of the Disclosure

Aspects of the present disclosure relate to wireless communications, and more particularly, to techniques for performing channel calculations, such as channel estimation and precoder calculation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Downlink channel estimation of a downlink channel between a network entity and a user equipment (UE) may be performed in order to determine how the network entity should send downlink data transmissions to the UE. For example, downlink data transmissions may be scheduled and sent using a modulation scheme, coding rate, number of transmission layers, etc., that is based on the downlink channel estimation.

In some cases, downlink channel estimation may be performed based on the network entity transmitting a signal, such as a channel state information reference signal (CSI-RS) to the UE. The UE receives and measures the signal to perform channel calculations for the downlink channel, such as determining a channel estimate, and in some cases, calculating a precoder (e.g., precoder matrix) to be used for precoding downlink data transmissions. The UE may then send an indication of the channel estimate and/or precoder to the network entity, such as in a channel state information (CSI) report, which may be a type of channel state feedback (CSF).

In some cases, downlink channel estimation may be performed based on the network entity receiving a signal, such as a sounding reference signal (SRS), from the UE. For example, in some cases, an uplink channel between the network entity and the UE may have reciprocity with a downlink channel between the network entity and the UE, in that the uplink channel and downlink channel have similar channel characteristics. The network entity may receive and measure the SRS to perform channel calculations on the uplink channel, such as to determine a channel estimate, and in some cases, calculate a precoder. The network entity may further determine that such channel estimate and/or precoder (or a channel estimate and/or precoder that is a function of the channel estimate and/or precoder) may be used for the downlink channel, based on the reciprocity between the downlink channel and the uplink channel.

SRS based downlink channel estimation may provide a more accurate channel estimate when a UE is near the center of a cell, such as closer to a base station, but may have performance degradation when the UE is near the edge of a cell, such as due to transmit power limitations of the UE. CSI-RS based downlink channel estimation may have stable performance, even when there is not reciprocity between the uplink channel and the downlink channel, and even at the edge of the cell, but there is communications overhead for the communication of the CSF. Accordingly, techniques are provided herein to allow the use of both SRS and CSI-RS to perform downlink channel estimation, which may improve channel estimates, leading to downlink data transmissions that are communicated more reliably between the UE and the network entity.

One aspect provides a method for wireless communications by an apparatus. The method includes sending signaling indicative of one or more power ratios, wherein each of the one or more power ratios is based on a transmit power for transmitting sounding reference signal (SRS) using a corresponding antenna and a receive power for receiving channel state information reference signal (CSI-RS) using the corresponding antenna, and wherein the one or more power ratios are associated with one or more antennas; sending a first CSI-RS; receiving a first SRS; receiving first channel state feedback (CSF) corresponding to the CSI-RS; and performing channel estimation based on the first CSF and the first SRS.

Another aspect provides a method for wireless communications by an apparatus. The method includes receiving signaling indicative of one or more power ratios, wherein each of the one or more power ratios is based on a transmit power for transmitting SRS using a corresponding antenna of the apparatus and a receive power for receiving CSI-RS using the corresponding antenna of the apparatus, and wherein the one or more power ratios are associated with one or more antennas of the apparatus; receiving a first CSI-RS using a first antenna of the one or more antennas; sending a first SRS using the first antenna; and sending first CSF corresponding to the CSI-RS.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software. In some examples, the one or more memories store processor-executable instructions. The one or more processors may execute the processor-executable instructions and cause the apparatus to perform any portion of any method described herein.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts a process flow for CSI reporting in a network between a network entity and a UE.

FIG. 6 depicts an example CSI machine learning (ML) encoder and an example CSI ML decoder.

FIG. 7 depicts a process flow for SRS based channel calculations in a network between a network entity and a UE.

FIG. 8 depicts aspects of an example network entity and a UE.

FIG. 9 depicts aspects of an example network entity and a UE.

FIG. 10 depicts aspects of an example network entity and a UE.

FIG. 11 depicts aspects of an example network entity and a UE.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for supporting downlink channel estimation based on both CSI-RS and SRS.

In certain aspects, a network entity is configured to utilize artificial intelligence/machine learning (AI/ML) techniques to calculate a channel estimate of a downlink channel and/or a precoder to use for precoding downlink data transmissions for transmission on the downlink channel. For example, the network entity includes a machine learning (ML) model configured to take as input a channel estimate and/or precoder received from a UE, such as CSF received from the UE, where the channel estimate and/or precoder are determined by the UE based on CSI-RS received at the UE from the network entity. The ML model is further configured to take as input a channel estimate and/or precoder determined by the network entity based on SRS received at the network entity from the UE. The ML model is further configured to output a channel estimate of the downlink channel and/or a precoder to use for precoding downlink data transmissions for transmission on the downlink channel. A technical effect of using such an ML model may be improved channel estimates and/or precoder calculations, leading to downlink data transmissions that are communicated more reliably between the UE and the network entity as parameters used for transmitting the downlink data transmissions may be based on such improved channel estimates and/or precoder calculations.

In certain aspects, in order for the ML model to use both the CSI-RS based input (e.g., channel estimate and/or precoder determined based on CSI-RS) and the SRS based input (e.g., channel estimate and/or precoder determined based on SRS), one or more power ratios between the CSI-RS input and SRS input need to be maintained. For example, a given power ratio may be based on a transmit power for transmitting SRS using a particular antenna of a UE and a receive power used to receive CSI-RS using the particular antenna of the UE. In certain aspects, the receive power used to receive CSI-RS using the particular antenna of the UE is based on a power gain applied to CSI-RS received using the particular antenna of the UE and/or a transmit power used by a network entity to transmit the CSI-RS. A UE may have more than one antenna used to transmit SRS and receive CSI-RS, and different antennas may be associated with the same or different power ratios.

The ML model may be trained on a dataset of pairs of CSI-RS based input and SRS based input, wherein each pair includes a corresponding CSI-RS based input and a corresponding SRS based input for which the ML model generates a corresponding output as discussed. In order to train the ML model, one or more power ratios between the CSI-RS based input and the SRS based input in each pair may need to be maintained across the dataset. In particular, if the power ratio changes, then a ratio of a channel estimate determined based on CSI-RS and a channel estimate based on SRS of a pair may change, since the transmit power used to transmit SRS and receive power used to receive CSI-RS affects the channel estimate (e.g., higher power leads to a higher channel estimate, lower power leads to a lower channel estimate). Therefore, in some cases, for the ML model to be trained to accurately weight the CSI-RS based input and the SRS based input to determine an output, the power ratio may need to remain constant across the dataset.

Accordingly, certain aspects herein provide techniques for communicating information indicative of one or more power ratios between the UE and the network entity. For example, the network entity may send signaling to the UE, the signaling indicating one or more power ratios, each of the one or more power ratios associated with a corresponding one or more antennas of the UE. In certain aspects, the UE may accordingly transmit SRS using a corresponding transmit power for each antenna and receive CSI-RS using a corresponding receive power for each antenna, such that the corresponding transmit power for a given antenna and the corresponding receive power for the given antenna match the power ratio for the given antenna. Accordingly, a technical effect may be that channel calculations based on such SRS and CSI-RS can be used to train the ML model if used during a training phase or such channel calculations can be input in the ML model to obtain a channel estimate and/or precoder if used during an inference phase.

In certain aspects, the UE may transmit SRS using a corresponding transmit power for each antenna and receive CSI-RS using a corresponding receive power for each antenna, such that the corresponding transmit power for a given antenna and the corresponding receive power for the given antenna does not match the power ratio for the given antenna used to train the ML model. In such aspects, the UE may send, to the network entity, an indication of one or more power ratios, including a power ratio of the corresponding transmit power for the given antenna and the corresponding receive power for the given antenna. The network entity may determine SRS based input based on the SRS transmitted by the UE, and receive CSI-RS based input from the UE that is based on the CSI-RS received by the UE. Before inputting the SRS based input and the CSI-RS based input into the ML model, the network entity may input one or more of the SRS based input or the CSI-RS based input into an input-shaper/pre-processor that processes the one or more of the SRS based input or the CSI-RS based input based on the one or more power ratios indicated to the network entity by the UE. In particular, the input-shaper/pre-processor may process the one or more of the SRS based input or the CSI-RS based input to account for the difference between 1) the one or more power ratios used to transmit the SRS and receive the CSI-RS; and 2) the one or more power ratios used to train the ML model. Accordingly, a technical effect may be that channel calculations based on such SRS and CSI-RS can be used to train the ML model if used during a training phase or such channel calculations can be input in the ML model to obtain a channel estimate and/or precoder if used during an inference phase, even if an actual power ratio used for the SRS and CSI-RS is different than a power ratio used to train the ML model.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

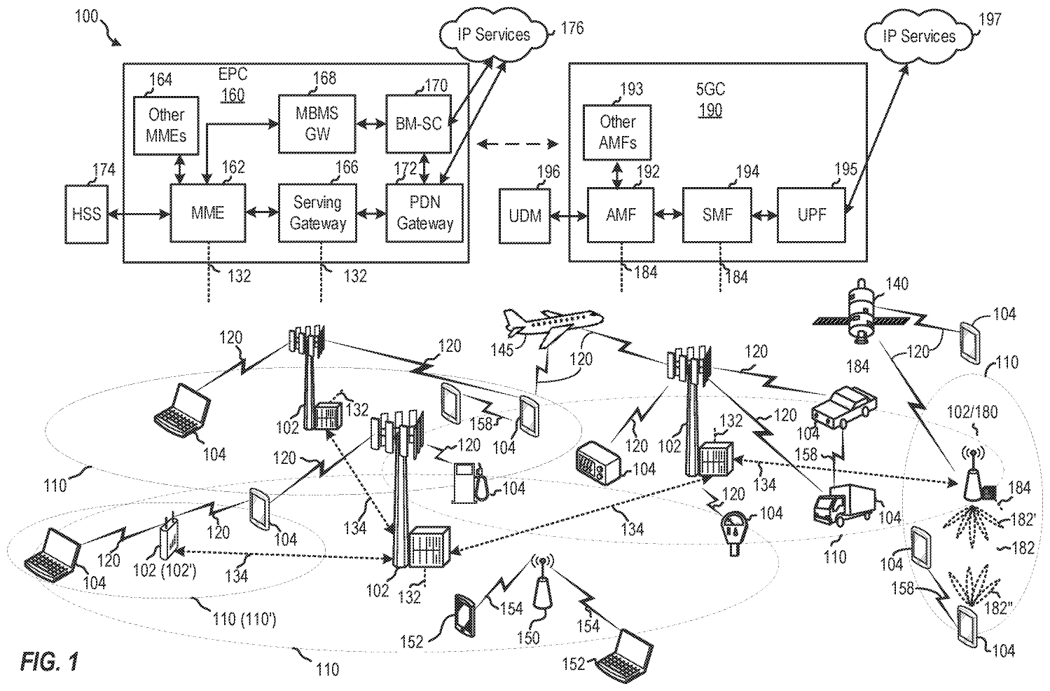

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

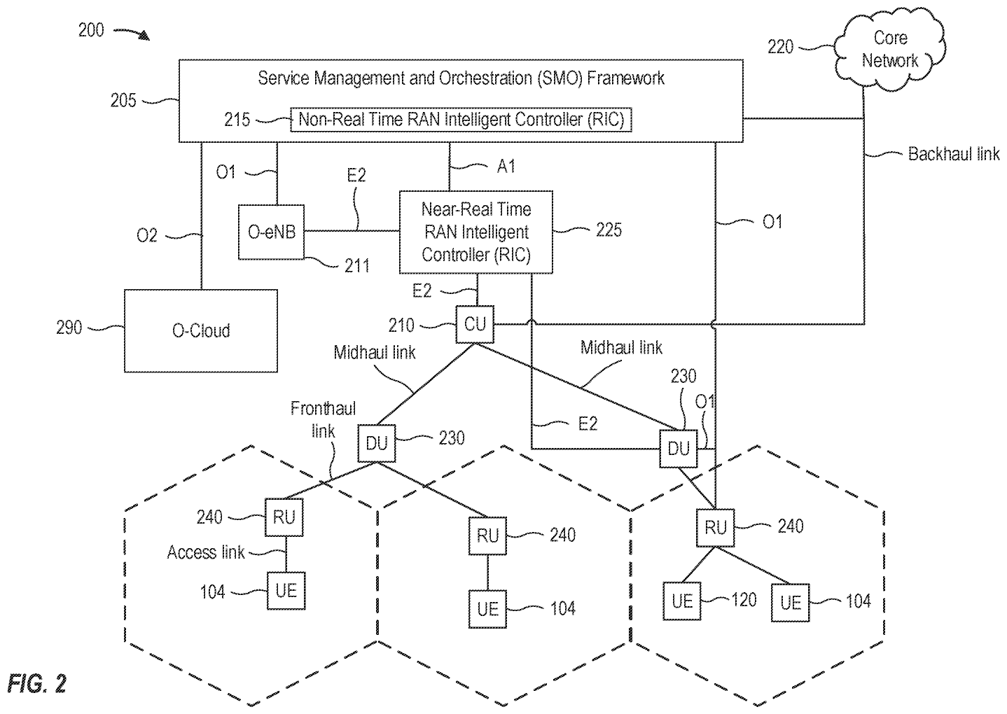

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

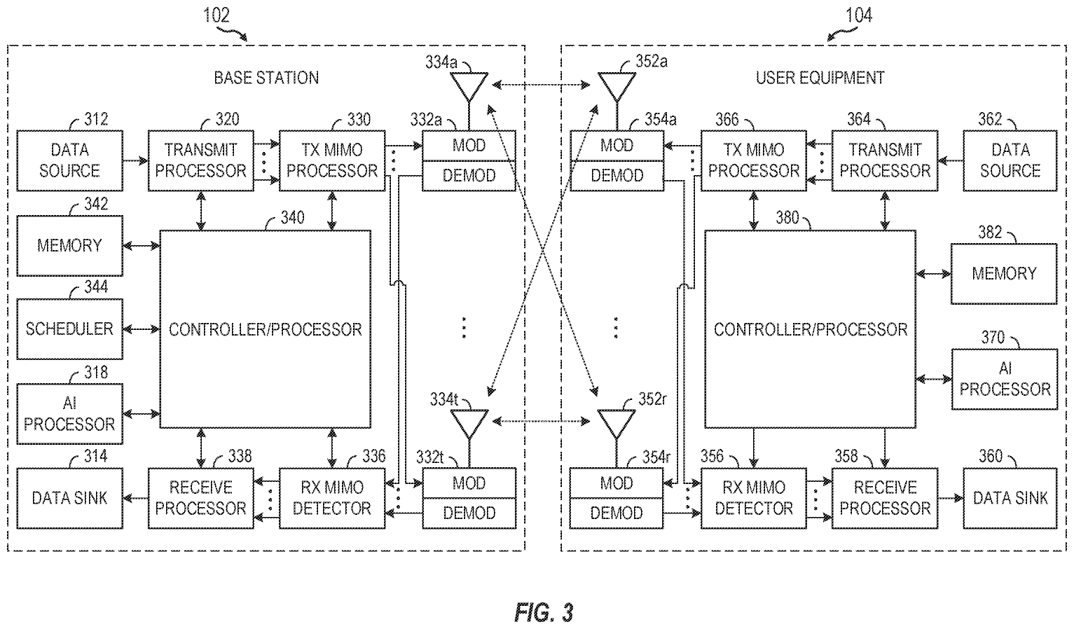

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

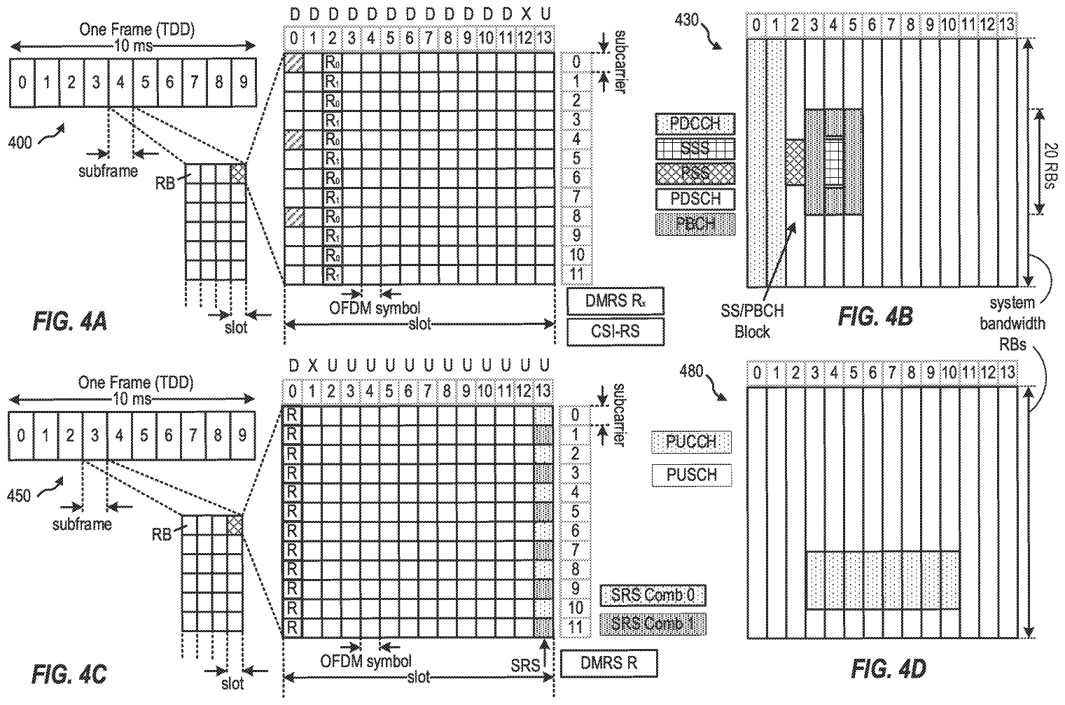

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where μ is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to CSI-RS Based Channel Calculations

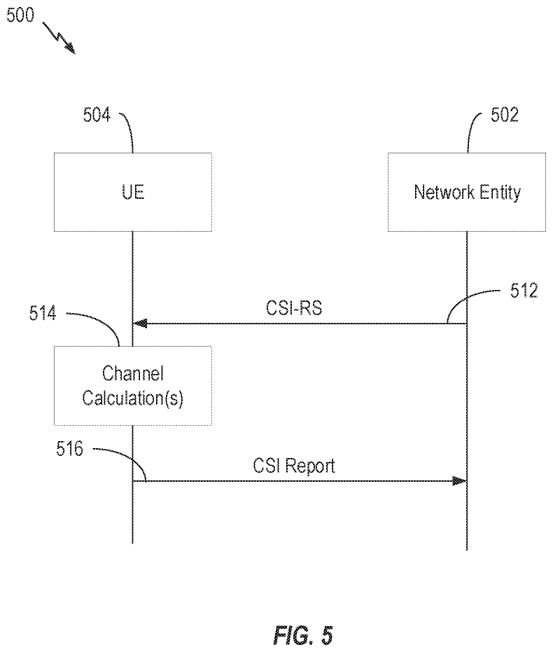

As discussed, a UE may be configured to perform CSI reporting. FIG. 5 depicts a process flow 500 for CSI reporting in a network between a network entity 502 and a UE 504. In some aspects, the network entity 502 may be an example of the BS 102 depicted and described with respect to FIGS. 1 and 3 or a disaggregated base station depicted and described with respect to FIG. 2. Similarly, the UE 504 may be an example of UE 104 depicted and described with respect to FIGS. 1 and 3. However, in other aspects, UE 504 may be another type of wireless communications device and network entity 502 may be another type of network entity or network node, such as those described herein.

At 512, UE 504 receives a CSI-RS (or other suitable signal) from network entity 502. At 514, UE 504 performs channel calculations based on the CSI-RS, such as determining a channel estimate H based on the received CSI-RS. For example, the UE 504 may include a demodulator, which may be part of a transceiver (e.g., transceiver 354 of FIG. 3), RX MIMO detector (e.g., RX MIMO detector 356 of FIG. 3), and/or receive processor (e.g., receive processor 358 of FIG. 3) of UE 504. The demodulator, such as a component of the demodulator, may take as input the CSI-RS as received over multiple antennas of the UE 504 and output a vector y that is a representation of the received CSI-RS as received over each of the multiple antennas of the UE 504.

Based on a received signal model, the vector y can be represented as follows in equation (1):

\vec{y}=H\tilde{x}+\vec{n} (1)

In equation (1), H corresponds to a matrix representation of the communications channel, as in a channel estimate of the communications channel the signal is communicated in (e.g., downlink communication channel where CSI-RS is communicated), \vec{x} is the vector representing symbols transmitted by network entity 502 over a number of spatial layers, and \vec{n} is thermal noise across the communications channel. In certain aspects, H has a size equal to <the number of antennas used to receive the signaling>×<the number of spatial layers> (e.g., the number of beamformed transmissions, number of antenna ports, etc.). For example, H has a number of rows equal to <the number of antennas used to receive the signaling> and a number of columns equal to <the number of spatial layers>. In certain aspects, the symbols that make up CSI-RS are known by UE 504 (e.g., configured or preconfigured at the UE). UE 504 can determine the channel estimate H based on receiving the CSI-RS.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 516, UE 504 sends to network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may define the number of possible layers for downlink transmission. PMI may define a set of indices corresponding to the precoding matrix V to apply to downlink transmissions. CQI may be an indicator of channel quality, such as corresponding to H. The UE 504 may then send an indication of the one or more determined CSI parameters to the network entity 502 in the CSI report. The network entity 502 may then schedule downlink data transmissions to the UE 504 accordingly, such as using a modulation scheme, coding rate, number of transmission layers, etc., that the network entity determines based on the CSI report.

In certain aspects, the UE 504 and network entity 502 may utilize AI/ML techniques to communicate CSF, such as to communicate the CSI report, which may be referred to as ML-based CSI reporting. For example, the UE 504 may include an ML-based encoder, which may be referred to as a CSI ML encoder, to derive an encoded (e.g., compressed) representation (also referred to as a latent representation or latent message) of the CSI report for transmission to the network entity 502. For example, the encoded representation of the CSI report may compress the CSI included in the CSI report. Further, the network entity 502 may include an ML-based decoder, which may be referred to as a CSI ML decoder, to decode (e.g., reconstruct, decompress, etc.) the CSI in the CSI report from the encoded representation of the CSI report. For example, the CSI ML encoder may be analogous to a PMI searching algorithm and the CSI ML decoder may be analogous to the PMI codebook and may be used to translate the bits in the CSI report to a PMI codeword. In certain aspects, the UE 504 and/or network entity 502 may include more than one ML model for implementing the CSI ML encoder and/or the CSI ML decoder, and each model may be associated with a different ML model identifier. In certain aspects, different ML models may be configured to accept different input(s) (e.g., H, V, etc.) or generate different output(s) (e.g., H, V, etc.).

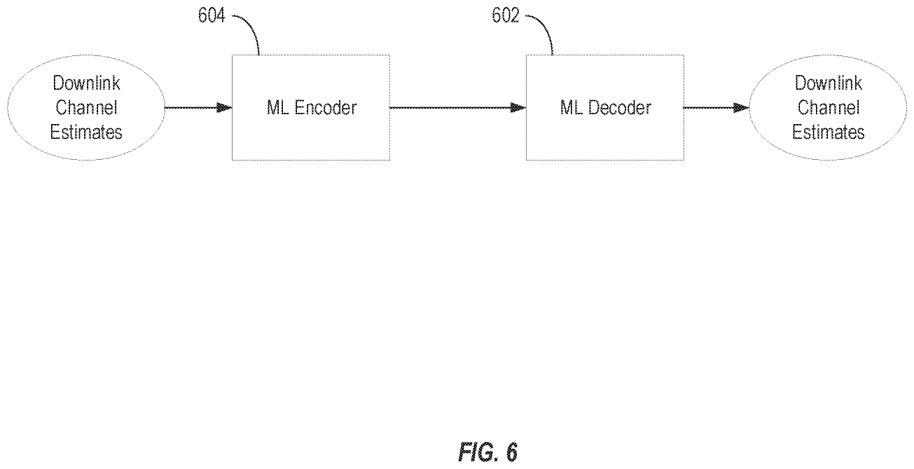

FIG. 6 depicts an example CSI ML encoder 604 and an example CSI ML decoder 602. The CSI ML encoder 604 may be implemented by one or more processors of a UE, such as UE 104 of FIGS. 1 and 3, or UE 504 of FIG. 5. For example, CSI ML encoder 604 may be implemented by one or more of receive processor 358, transmit processor 364, TX MIMO processor 366, AI processor 370, and/or controller/processor 380, as described with respect to FIG. 3. The CSI ML decoder 602 may be implemented by one or more processors of a network entity, such as BS 102 of FIGS. 1 and 3, or a disaggregated base station as discussed with respect to FIG. 2, or network entity 502 of FIG. 5. For example, CSI ML decoder 602 may be implemented by one or more of receive processor 338, transmit processor 320, TX MIMO processor 330, AI processor 318, and/or controller/processor 340, as described with respect to FIG. 3.

CSI ML encoder 604 is configured to receive downlink channel estimate H and/or precoder V, such as corresponding to measurements of one or more signals such as CSI-RS. The downlink channel estimate H and/or precoder V, as discussed, may correspond to a CSI report including one or more CSI parameters. The CSI ML encoder 604 is configured to derive an encoded (e.g., compressed) representation (also referred to as a latent representation or latent message) of the CSI report. For example, the encoded representation of the CSI report may compress the CSI included in the CSI report. The CSI ML encoder 604 may utilize an ML model to encode the CSI report. The ML model may be any suitable type of ML model, such as a neural network trained on input data to output the encoded representation of the CSI report. The ML model may include one or more hidden layers to process the CSI report, and an output layer that outputs the encoded representation of the CSI report.

CSI ML decoder 602 is configured to receive the encoded representation of the CSI report and decode (e.g., reconstruct, decompress, etc.) the CSI in the CSI report from the encoded representation of the CSI report. The CSI ML decoder 602 may utilize an ML model to decode the encoded representation of the CSI report. The ML model may be any suitable type of ML model, such as a neural network trained on input data to output the CSI report. The ML model may include one or more hidden layers to process the encoded representation of the CSI report, and an output layer that outputs the CSI report.

### Aspects Related to SRS Based Channel Calculations

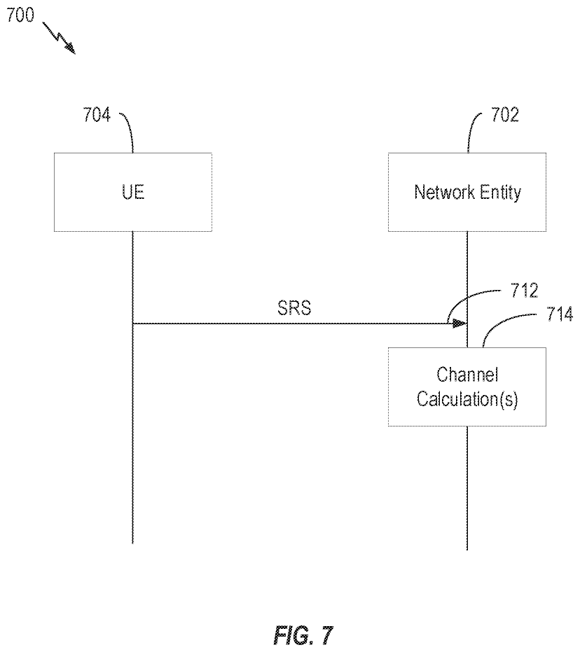

As discussed, a UE may be configured to transmit SRS, which a network entity is configured to measure to perform channel calculations. FIG. 7 depicts a process flow 700 for SRS based channel calculations in a network between a network entity 702 and a UE 704. In some aspects, the network entity 702 may be an example of the BS 102 depicted and described with respect to FIGS. 1 and 3 or a disaggregated base station depicted and described with respect to FIG. 2. Similarly, the UE 704 may be an example of UE 104 depicted and described with respect to FIGS. 1 and 3. However, in other aspects, UE 704 may be another type of wireless communications device and network entity 702 may be another type of network entity or network node, such as those described herein.

At 712, UE 704 sends an SRS (or other suitable signal) to network entity 702. At 714, network entity 702 performs channel calculations based on the SRS, such as determining a channel estimate H based on the received SRS. For example, the network entity 702 may include a demodulator, which may be part of a transceiver (e.g., transceiver 332 of FIG. 3), RX MIMO detector (e.g., RX MIMO detector 336 of FIG. 3), and/or receive processor (e.g., receive processor 338 of FIG. 3) of network entity 702. The demodulator, such as a component of the demodulator, may take as input the SRS as received over multiple antennas of the network entity 702 and output a vector y that is a representation of the received SRS as received over each of the multiple antennas of the network entity 702.

As discussed, the vector y can be represented by equation (1), wherein in this case, H corresponds to a matrix representation of the communications channel, as in a channel estimate of the communications channel the signal is communicated in (e.g., uplink communication channel where SRS is communicated), x is the vector representing symbols transmitted by UE 704 over a number of spatial layers, and \vec{n} is thermal noise across the communications channel. In certain aspects, H has a size equal to <the number of antennas used to receive the signaling>×<the number of spatial layers> (e.g., the number of beamformed transmissions, number of antenna ports, etc.). For example, H has a number of rows equal to <the number of antennas used to receive the signaling> and a number of columns equal to <the number of spatial layers>. In certain aspects, the symbols that make up SRS are known by network entity 702 (e.g., configured or preconfigured at the network entity). Network entity 702 can determine the channel estimate H based on receiving the SRS.

In certain aspects, network entity 702 may further calculate, as part of the channel calculations, a precoder (e.g., precoder matrix) V based on the channel estimate H. For example, network entity 702 may be configured to perform SVD based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

Accordingly, network entity 702 may determine H and/or V for an uplink channel between UE 704 and network entity 702 based on SRS. Further, as discuss, the uplink channel between UE 704 and network entity 702 may have reciprocity with a downlink channel between UE 704 and network entity 702. Accordingly, the determined values of H and/or V for the uplink channel between UE 704 and network entity 702 may be used for the downlink channel between UE 704 and network entity 702. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 702 may apply a function to H and/or V determined for the uplink channel.

### Aspects Related to CSI-RS and SRS Based Channel Calculations

As discussed, in certain aspects, a network entity is configured to utilize AI/ML techniques to calculate a channel estimate of a downlink channel and/or a precoder to use for precoding downlink data transmissions for transmission on the downlink channel. For example, the network entity includes a ML model configured to take as input a channel estimate and/or precoder received from a UE, such as CSF received from the UE, where the channel estimate and/or precoder are determined by the UE based on CSI-RS received at the UE from the network entity. The ML model is further configured to take as input a channel estimate and/or precoder determined by the network entity based on SRS received at the network entity from the UE. The ML model is further configured to output a channel estimate of the downlink channel and/or a precoder to use for precoding downlink data transmissions for transmission on the downlink channel.

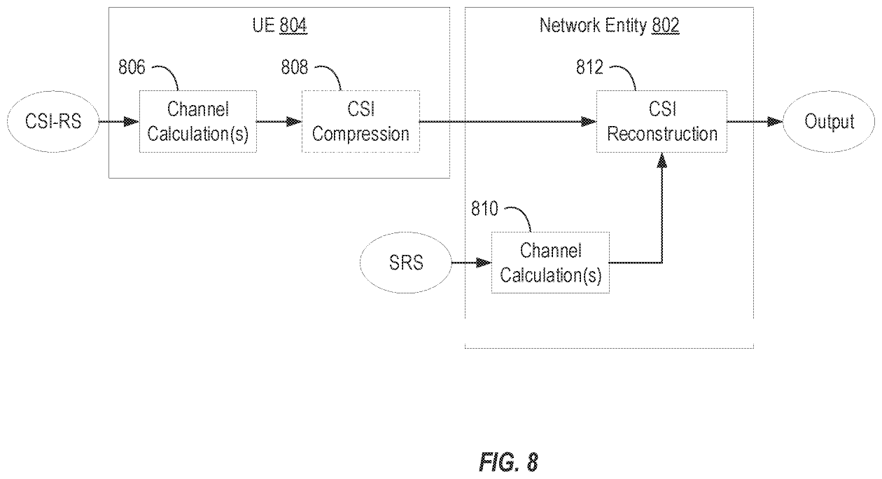

FIG. 8 depicts aspects of an example network entity 802 and a UE 804. In some aspects, the network entity 802 may be an example of the BS 102 depicted and described with respect to FIGS. 1 and 3 or a disaggregated base station depicted and described with respect to FIG. 2. Similarly, the UE 804 may be an example of UE 104 depicted and described with respect to FIGS. 1 and 3. However, in other aspects, UE 804 may be another type of wireless communications device and network entity 802 may be another type of network entity or network node, such as those described herein.

As shown, UE 804 is configured to perform channel calculation(s) 806 based on receiving a CSI-RS, such as described with respect to FIG. 5. For example, UE 804 may determine a channel estimate H₁ and/or precoder V₁ for a downlink channel between UE 804 and network entity 802, and send in indication of the channel estimate H₁ and/or precoder V₁ to network entity 802. In certain aspects, UE 804 is configured to generate a CSI report indicative of channel estimate H₁ and/or precoder V₁ as discussed. Optionally, UE 804 is configured to perform CSI compression 808, to compress the CSI report, such as using an ML model, such as discussed with respect to ML encoder 604 of FIG. 6. It should be noted that, in certain aspects, UE 804 does not perform CSI compression 808.

Further, as shown, network entity 802 is configured to perform channel calculation(s) 810 based on receiving a SRS, such as described with respect to FIG. 7. For example, network entity 802 may determine a channel estimate H₂ and/or precoder V₂ for the downlink channel between UE 804 and network entity 802.

Network entity 802 is further configured to perform CSI reconstruction 812 to determine a channel estimate H₃ and/or precoder V₃ for the downlink channel between UE 804 and network entity 802 based on 1) channel estimate H₁ and/or precoder V₁; and 2) channel estimate H₂ and/or precoder V₂. For example, network entity 802 may use an ML model to use both the CSI-RS based input (channel estimate H₁ and/or precoder V₁) and the SRS based input (channel estimate H₂ and/or precoder V₂) to determine a channel estimate H₃ and/or precoder V₃ for the downlink channel that is based on both the CSI-RS based input and the SRS based input. For example, the ML model may take as input the CSI-RS based input and the SRS based input and output the channel estimate H₃ and/or precoder V₃.

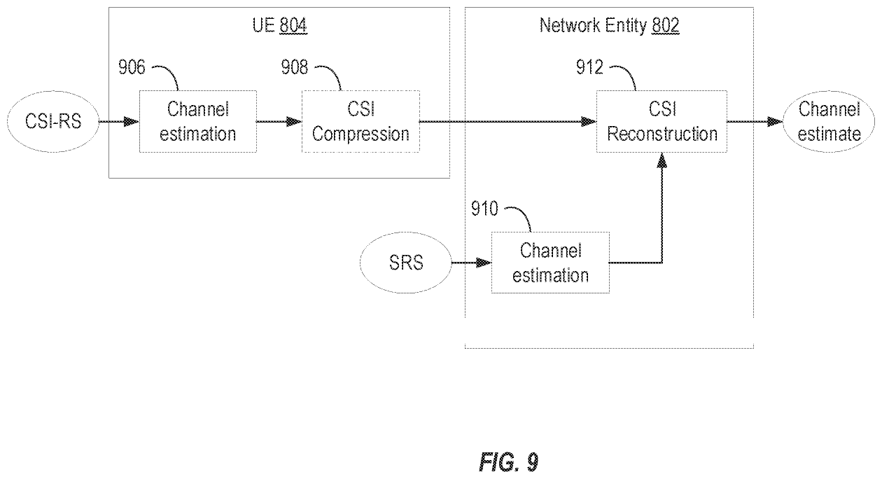

The ML model may run, for example, on one or more processors of network entity 802, such as one or more of receive processor 338, transmit processor 320, TX MIMO processor 330, AI processor 318, and/or controller/processor 340, as described with respect to FIG. 3. In certain aspects, the ML model may run on ML decoder 602 of FIG. 6. In certain aspects, the ML model may be trained to take particular input, and generate particular output, such as based on a dataset including a number of inputs and corresponding outputs, as further discussed herein. The ML model may be trained on the network entity 802 and/or one or more other computing devices. The dataset may include measured data, simulated data, and/or the like. The network entity 802 may include different ML models trained on different datasets, such as different ML models that are trained to take different inputs and/or provide different outputs, such as corresponding to examples further discussed herein with respect to FIGS. 9-11. In certain aspects, where the ML model is indicated to take as input the CSI-RS based input (channel estimate H₁ and/or precoder V₁), the ML model may be configured to take as input a particular type of representation of the CSI-RS based input, such as a compressed representation based on CSI compression 808, an uncompressed representation, a CSI report, or the like. Any suitable training technique may be used for the ML model, and the ML model may be any suitable type of ML model (e.g., a neural network).

FIG. 9 depicts aspects of an example of network entity 802 and an example of UE 804. In the example of FIG. 9, network entity 802 is configured to perform CSI reconstruction 912 (e.g., an example of CSI reconstruction 812) to determine the channel estimate H₃ based on channel estimate H₁ and channel estimate H₂. In particular, UE 804 is configured to perform channel estimation 906 (e.g., an example of channel calculation(s) 806) based on receiving a CSI-RS to determine H₁. Optionally, UE 804 performs CSI compression 908 (e.g., an example of CSI compression 808). UE 804 sends an indication of channel estimate H₁ to network entity 802, as discussed. Network entity 802 is configured to perform channel estimation 910 (e.g., an example of channel calculation(s) 810) based on receiving a SRS to determine H₂.

In certain aspects, for network entity 802 to determine the channel estimate H₃ based on channel estimate H₁ and channel estimate H₂ a number of criteria related to antenna settings and mappings may need to be met. For example, the number of antennas used to estimate H₁ may need to be the same as the number of antennas used to estimate H₂ such that H₁ and H₂ have the same number of rows. Further, an ordering of the antennas as represented by rows of H₁ and H₂ may need to be the same, such as row 1 of H₁ needs to represent the same antenna(s) as row 1 of H₂. For example, row 1 of H₁ may represent communication of CSI-RS using a first antenna of network entity 802 and a first antenna of UE 804. Accordingly, row 1 of H₂ may also need to represent communication of SRS using the first antenna of network entity 802 and the first antenna of UE 804.

Further, in certain aspects, for network entity 802 to determine the channel estimate H₃ based on channel estimate H₁ and channel estimate H₂, one or more power ratios between H₁ and H₂ as input into the ML model may need to be maintained, as discussed. For example, as discussed, for each pair H₁ and H₂, for each antenna of UE 804 for which the channel is estimated, a power ratio associated with transmitting SRS and receiving CSI-RS may need to be maintained, as discussed. The power ratio may be maintained by actually transmitting SRS and receiving CSI-RS according to the power ratio, or adjusting the value of H₁ and/or H₂ to account for transmitting SRS and receiving CSI-RS according to a different power ratio.

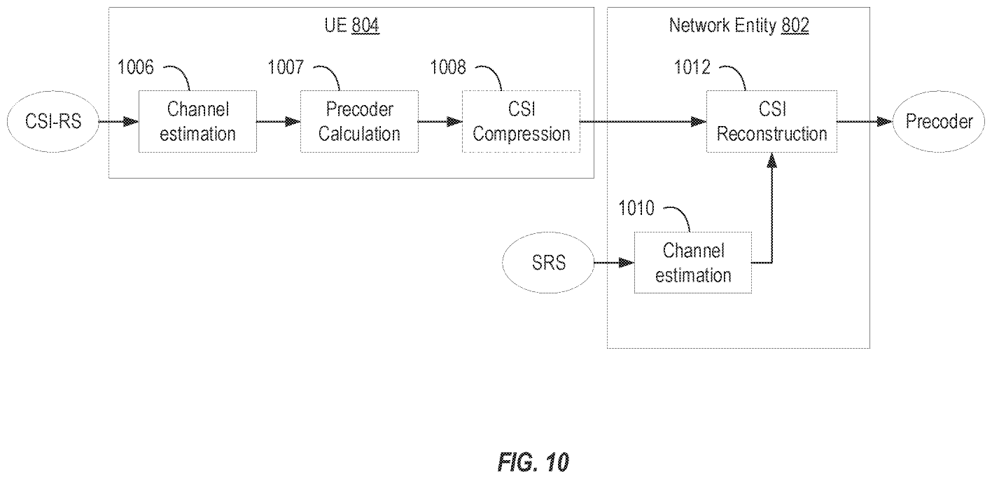

FIG. 10 depicts aspects of an example of network entity 802 and an example of UE 804. In the example of FIG. 10, network entity 802 is configured to perform CSI reconstruction 1012 (e.g., an example of CSI reconstruction 812) to determine the precoder V₃ based on precoder V₁ and channel estimate H₂. In particular, UE 804 is configured to perform channel estimation 1006 (e.g., an example of channel calculation(s) 806) based on receiving a CSI-RS to determine H₁. Further, UE 804 is configured to perform precoder calculation 1007 (e.g., an example of channel calculation(s) 806) to calculate precoder V₁ based on H₁, as discussed. Optionally, UE 804 performs CSI compression 1008 (e.g., an example of CSI compression 808). UE 804 sends an indication of precoder V₁ to network entity 802, as discussed. Network entity 802 is configured to perform channel estimation 1010 (e.g., an example of channel calculation(s) 810) based on receiving a SRS to determine H₂.

In certain aspects, for network entity 802 to determine the precoder V₃ based on precoder V₁ and channel estimate H₂ a number of criteria may need to be met. For example, the number of spatial layers used to determine V₁ may need to be the same as the number of spatial layers used to estimate H₂, meaning the number of spatial layers over which CSI-RS is communicated may need to be the same as the number of spatial layers over which SRS may need to be communicated. An ordering of the antennas as represented by rows of H₁ and H₂ may not need to be the same, as the order may not impact calculation of a precoder V.

Further, in certain aspects, for network entity 802 to determine the precoder V₃ based on precoder V₁ and channel estimate H₂, one or more power ratios between V₁ (based on H₁) and H₂ as input into the ML model may need to be maintained, as discussed. For example, as discussed, for each pair V₁ and H₂, for each antenna of UE 804 for which the channel is calculated, a power ratio associated with transmitting SRS and receiving CSI-RS may need to be maintained, as discussed. The power ratio may be maintained by actually transmitting SRS and receiving CSI-RS according to the power ratio, or adjusting the value of V₁ and/or H₂ to account for transmitting SRS and receiving CSI-RS according to a different power ratio.

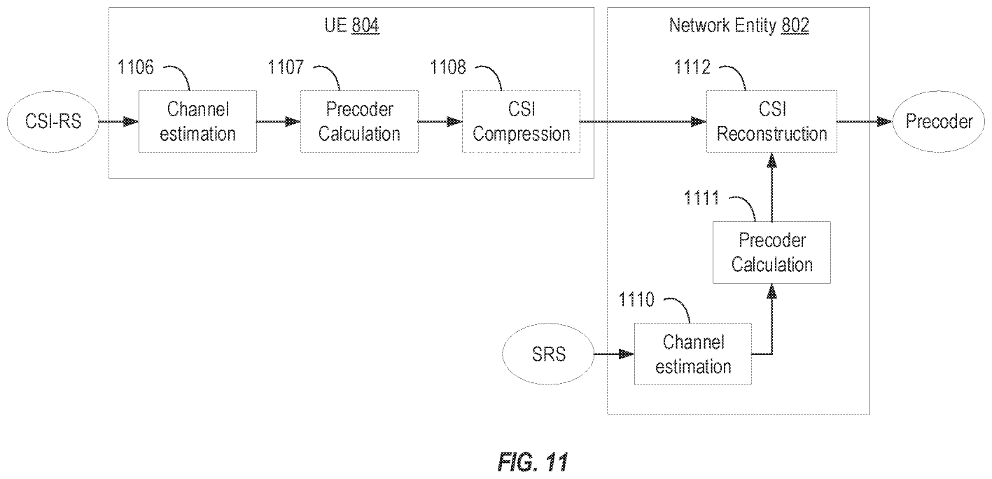

FIG. 11 depicts aspects of an example of network entity 802 and an example of UE 804. In the example of FIG. 11, network entity 802 is configured to perform CSI reconstruction 1112 (e.g., an example of CSI reconstruction 812) to determine the precoder V₃ based on precoder V₁ and precoder V₂. In particular, UE 804 is configured to perform channel estimation 1106 (e.g., an example of channel calculation(s) 806) based on receiving a CSI-RS to determine H₁. Further, UE 804 is configured to perform precoder calculation 1107 (e.g., an example of channel calculation(s) 806) to calculate precoder V₁ based on H₁, as discussed. Optionally, UE 804 performs CSI compression 1108 (e.g., an example of CSI compression 808). UE 804 sends an indication of precoder V₁ to network entity 802, as discussed. Network entity 802 is configured to perform channel estimation 1110 (e.g., an example of channel calculation(s) 810) based on receiving a SRS to determine H₂. Further, network entity 802 is configured to perform precoder calculation 1111 (e.g., an example of channel calculation(s) 810) to calculate precoder V₂ based on H₂, as discussed.

In certain aspects, for network entity 802 to determine the precoder V₃ based on precoder V₁ and precoder V₂ a number of criteria may need to be met. For example, the number of spatial layers used to determine V₁ may need to be the same as the number of spatial layers used to determine V₂, meaning the number of spatial layers over which CSI-RS is communicated may need to be the same as the number of spatial layers over which SRS may need to be communicated. An ordering of the antennas as represented by rows of H₁ and H₂ may not need to be the same, as the order may not impact calculation of a precoder V.

Further, in certain aspects, for network entity 802 to determine the precoder V₃ based on precoder V₁ and precoder V₂, one or more power ratios between V₁ and V₂ as input into the ML model may need to be maintained, as discussed. For example, as discussed, for each pair V₁ and V₂, for each antenna of UE 804 for which the channel is calculated, a power ratio associated with transmitting SRS and receiving CSI-RS may need to be maintained, as discussed. The power ratio may be maintained by actually transmitting SRS and receiving CSI-RS according to the power ratio, or adjusting the value of V₁ and/or V₂ to account for transmitting SRS and receiving CSI-RS according to a different power ratio.

### Aspects Related to Communicating Power Ratio Information

As discussed, in some cases, for an ML model to be trained to accurately weight the CSI-RS based input and the SRS based input to determine an output, the power ratio may need to remain constant across a dataset. Accordingly, certain aspects herein provide techniques for communicating information indicative of one or more power ratios between the UE and the network entity. For example, in certain aspects, the network entity is configured to send signaling indicative of one or more power ratios to a UE.

In certain aspects, a network entity and/or a UE may be configured with a power based quasi-co-location (QCL), such as to be used for data collection for training and/or utilizing an ML model for performing channel calculations as discussed herein. There may be one or more types of power based QCL. The QCL type may indicate one or more power ratios. Accordingly, in certain aspects, the signaling sent by the network entity to the UE may indicate a QCL type associated with one or more power ratios.

In certain aspects, a QCL type may be associated with fixed (e.g., predefined) one or more power ratios. For example, a QCL type may be associated with a single power ratio associated with all antennas of a UE, different power ratios associated with different antennas of a UE, etc. Accordingly, the signaling indicating the QCL type may signal to use the fixed one or more power ratios.

In certain aspects, a QCL type may be associated with a UE indicating at least one supported power ratio the UE is capable of using (e.g., based on an ML model of an ML encoder of the UE, based on transmit power limits, etc.), and the network entity signaling one or more power ratios to the UE based on the at least one supported power ratio (e.g., selected from the at least one supported power ratio). For example, the at least one supported power ratio may be a single supported power ratio or multiple supported power ratios for all antennas of a UE, or a different single supported power ratio or different multiple supported power ratios for different antennas of the UE. Similarly, the one or more power ratios signaled to the UE may be a single power ratio associated with all antennas of a UE, different power ratios associated with different antennas of a UE, etc.

In certain aspects, a QCL type may be associated with the UE sending, to the network entity, an indication of one or more actual power ratios between transmitted SRS and received CSI-RS for one or more antennas of the UE together with CSF, such as with a CSI report as discussed.

In certain aspects, a QCL type may be associated with mappings of power ratios to identifiers of ML models. For example, different ML models that can be used by the network entity to perform channel calculations, as discussed herein, may be associated with different power ratio(s). Accordingly, the signaling indicative of one or more power ratios may include an identifier of an ML model associated with the one or more power ratios.

In certain aspects, a data format for data collection (e.g., UL data collection, such as channel calculations based on SRS, and/or DL data collection, such as channel calculations based on CSI-RS) may be defined in standards and/or agreed separately, such that the one or more power ratios may be defined according to the data format. In particular, a power ratio may not be a direct ratio of transmit power to receive power, but may be a function of the transmit power to a function of the receive power (or the inverse). Accordingly, the data format may define the function of the transmit power and the function of the receive power.

In certain aspects, the data format may also define a threshold time period between when CSI-RS is communicated and when SRS is communicated of a CSI-RS and SRS pair used to generate input for an ML model. In certain aspects, the threshold time period may be different for different SRS switching settings.

### Example Operations

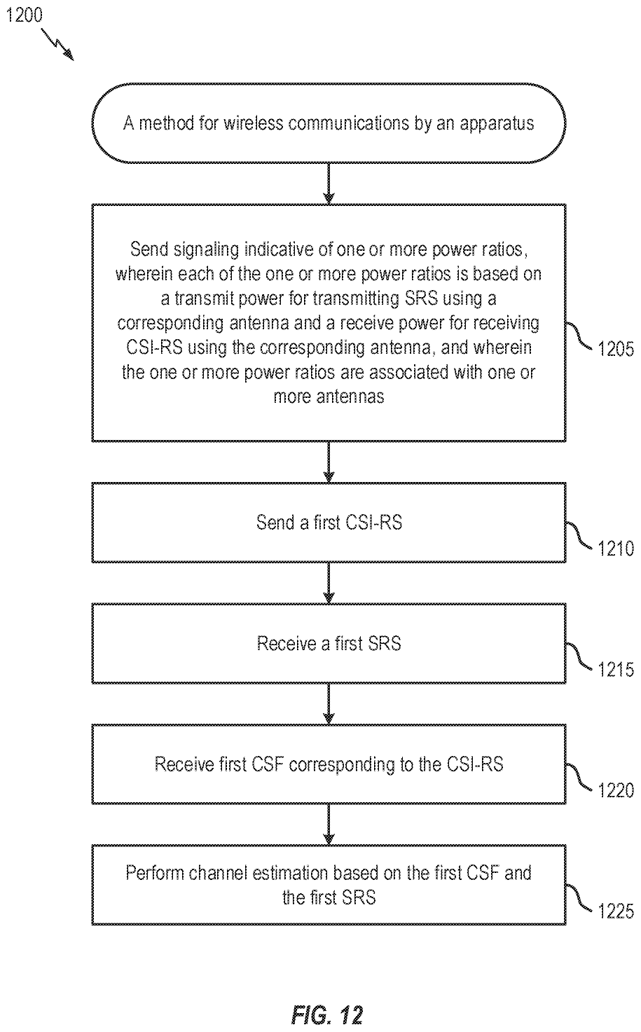

FIG. 12 shows a method 1200 for wireless communications by an apparatus, such as BS 102 of FIGS. 1 and 3, or a disaggregated base station as discussed with respect to FIG. 2.

Method 1200 begins at step 1205 with sending signaling indicative of one or more power ratios, wherein each of the one or more power ratios is based on a transmit power for transmitting SRS using a corresponding antenna and a receive power for receiving CSI-RS using the corresponding antenna, and wherein the one or more power ratios are associated with one or more antennas.

Method 1200 then proceeds to step 1210 with sending a first CSI-RS.

Method 1200 then proceeds to step 1215 with receiving a first SRS.

Method 1200 then proceeds to step 1220 with receiving first CSF corresponding to the CSI-RS.

Method 1200 then proceeds to step 1225 with performing channel estimation based on the first CSF and the first SRS.

In certain aspects, the signaling indicates a QCL type associated with the one or more power ratios.

In certain aspects, method 1200 further includes receiving an indication of at least one supported power ratio, wherein the at least one supported power ratio comprises the one or more power ratios.

In certain aspects, the first CSF comprises an indication of at least one power ratio of the one or more power ratios.

In certain aspects, the signaling indicates an identifier of a machine learning model associated with the one or more power ratios.

In certain aspects, each of the one or more power ratios is a ratio of a function of the transmit power to a function of the receive power.

In certain aspects, the first CSI-RS is sent within a threshold time period of when the first SRS is received.

In certain aspects, the CSF comprises a first channel estimate, and step 1225 includes: determining a second channel estimate based on the first SRS; inputting the first channel estimate and the second channel estimate into a machine learning model; and outputting, from the machine learning model, a third channel estimate.

In certain aspects, the CSF comprises a first precoder matrix, and step 1225 includes: determining a first channel estimate based on the first SRS; inputting the first channel estimate and the first precoder matrix into a machine learning model; and outputting, from the machine learning model, a second precoder matrix.

In certain aspects, the CSF comprises a first precoder matrix, and step 1225 includes: determining a second precoder matrix based on the first SRS; inputting the first precoder matrix and the second precoder matrix into a machine learning model; and outputting, from the machine learning model, a third precoder matrix.

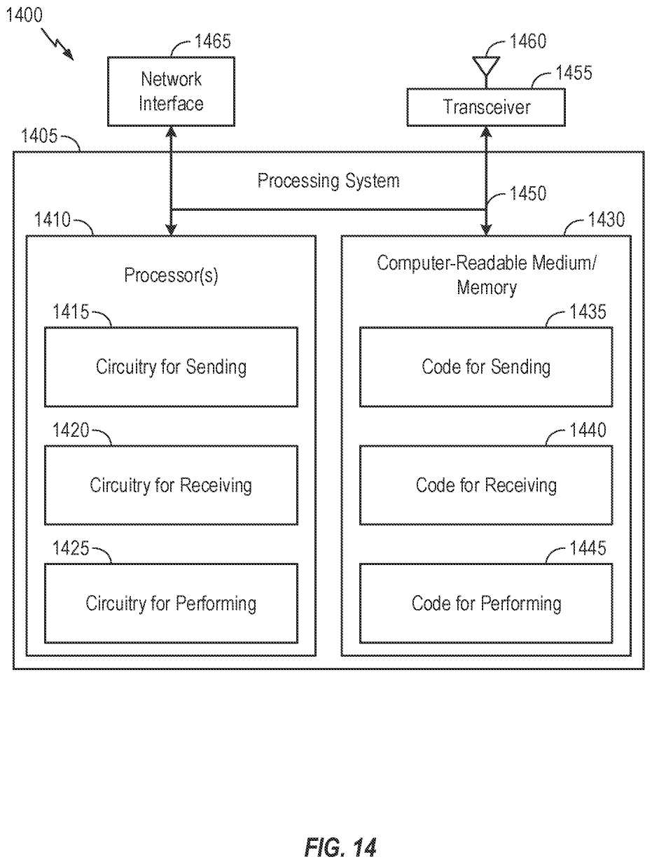

In certain aspects, method 1200, or any aspect related to it, may be performed by an apparatus, such as communications device 1400 of FIG. 14, which includes various components operable, configured, or adapted to perform the method 1200.

Communications device 1400 is described below in further detail.

Note that FIG. 12 is just one example of a method, and other methods including fewer, additional, or alternative steps are possible consistent with this disclosure.

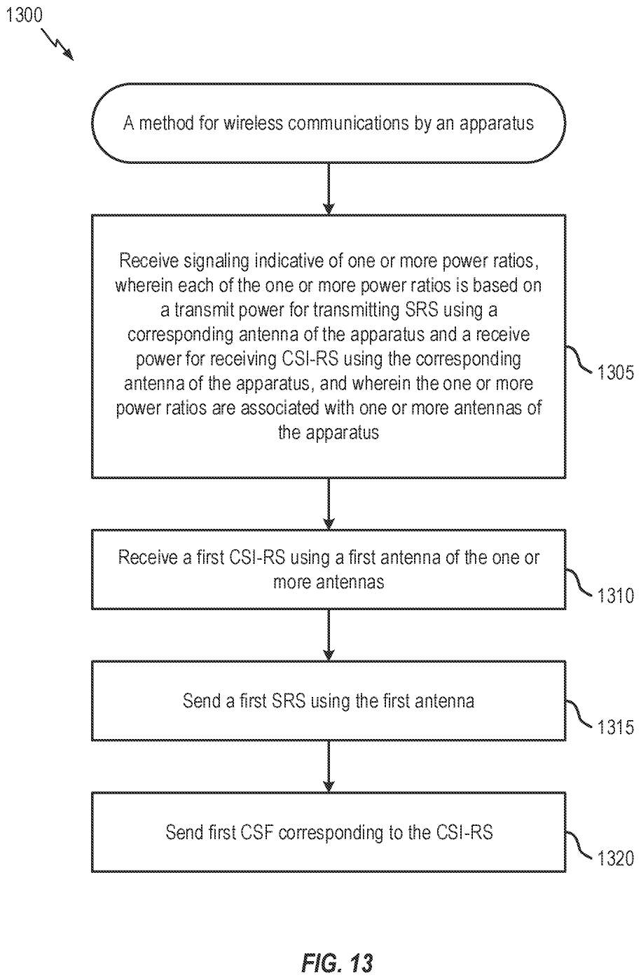

FIG. 13 shows a method 1300 for wireless communications by an apparatus, such as UE 104 of FIGS. 1 and 3.

Method 1300 begins at step 1305 with receiving signaling indicative of one or more power ratios, wherein each of the one or more power ratios is based on a transmit power for transmitting SRS using a corresponding antenna of the apparatus and a receive power for receiving CSI-RS using the corresponding antenna of the apparatus, and wherein the one or more power ratios are associated with one or more antennas of the apparatus.

Method 1300 then proceeds to step 1310 with receiving a first CSI-RS using a first antenna of the one or more antennas.

Method 1300 then proceeds to step 1315 with sending a first SRS using the first antenna.

Method 1300 then proceeds to step 1320 with sending first CSF corresponding to the CSI-RS.

In certain aspects, the signaling indicates a QCL type associated with the one or more power ratios.

In certain aspects, method 1300 further includes sending an indication of at least one supported power ratio, wherein the at least one supported power ratio comprises the one or more power ratios.

In certain aspects, the first CSF comprises an indication of at least one power ratio of the one or more power ratios.

In certain aspects, the signaling indicates an identifier of a machine learning model associated with the one or more power ratios.

In certain aspects, each of the one or more power ratios is a ratio of a function of the transmit power to a function of the receive power.

In certain aspects, the first CSI-RS is received within a threshold time period of when the first SRS is sent.

In certain aspects, method 1300 further includes receiving an identifier of a machine learning model.

In certain aspects, method 1300 further includes determining the first CSF based on the CSI-RS and the identifier of the machine learning model.

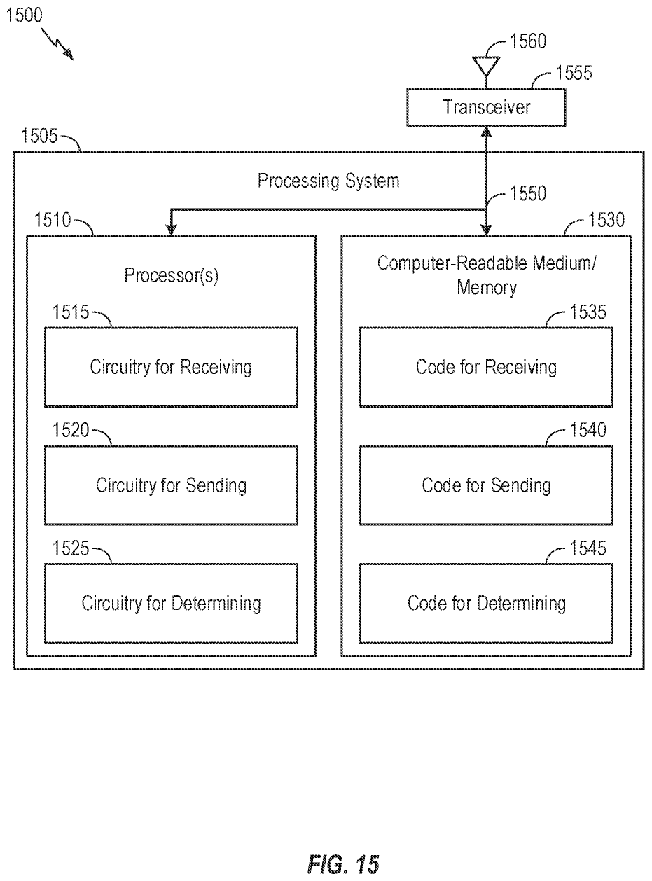

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Communications Devices

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1455 (e.g., a transmitter and/or a receiver) and/or a network interface 1465. The transceiver 1455 is configured to transmit and receive signals for the communications device 1400 via an antenna 1460, such as the various signals as described herein. The network interface 1465 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1430 via a bus 1450. In certain aspects, the computer-readable medium/memory 1430 is configured to store instructions (e.g., computer-executable code) that when executed by the one or more processors 1410, enable and cause the one or more processors 1410 to perform the method 1200 described with respect to FIG. 12, or any aspect related to it, including any additional steps or sub-steps described in relation to FIG. 12. Note that reference to a processor of communications device 1400 performing a function may include one or more processors of communications device 1400 performing that function, such as in a distributed fashion.

In the depicted example, the computer-readable medium/memory 1430 stores code for sending 1435, code for receiving 1440, and code for performing 1445. Processing of the code 1435-1445 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1430, including circuitry for sending 1415, circuitry for receiving 1420, and circuitry for performing 1425. Processing with circuitry 1415-1425 may enable and cause the communications device 1400 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1455 and/or antenna 1460 of the communications device 1400 in FIG. 14, and/or one or more processors 1410 of the communications device 1400 in FIG. 14. Means for communicating, receiving or obtaining may include the transceivers 332, antenna(s) 334, receive processor 338, and/or controller/processor 340 of the BS 102 illustrated in FIG. 3, transceiver 1455 and/or antenna 1460 of the communications device 1400 in FIG. 14, and/or one or more processors 1410 of the communications device 1400 in FIG. 14.

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to a transceiver 1555 (e.g., a transmitter and/or a receiver). The transceiver 1555 is configured to transmit and receive signals for the communications device 1500 via an antenna 1560, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, enable and cause the one or more processors 1510 to perform the method 1300 described with respect to FIG. 13, or any aspect related to it, including any additional steps or sub-steps described in relation to FIG. 13. Note that reference to a processor performing a function of communications device 1500 may include one or more processors performing that function of communications device 1500, such as in a distributed fashion.

In the depicted example, computer-readable medium/memory 1530 stores code for receiving 1535, code for sending 1540, and code for determining 1545. Processing of the code 1535-1545 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1530, including circuitry for receiving 1515, circuitry for sending 1520, and circuitry for determining 1525. Processing with circuitry 1515-1525 may enable and cause the communications device 1500 to perform the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1555 and/or antenna 1560 of the communications device 1500 in FIG. 15, and/or one or more processors 1510 of the communications device 1500 in FIG. 15. Means for communicating, receiving or obtaining may include the transceivers 354, antenna(s) 352, receive processor 358, and/or controller/processor 380 of the UE 104 illustrated in FIG. 3, transceiver 1555 and/or antenna 1560 of the communications device 1500 in FIG. 15, and/or one or more processors 1510 of the communications device 1500 in FIG. 15.

### Example Clauses

Implementation examples are described in the following numbered clauses:

Clause 1: A method for wireless communications by an apparatus comprising: sending signaling indicative of one or more power ratios, wherein each of the one or more power ratios is based on a transmit power for transmitting SRS using a corresponding antenna and a receive power for receiving CSI-RS using the corresponding antenna, and wherein the one or more power ratios are associated with one or more antennas; sending a first CSI-RS; receiving a first SRS; receiving first CSF corresponding to the CSI-RS; and performing channel estimation based on the first CSF and the first SRS.

Clause 2: The method of Clause 1, wherein the signaling indicates a QCL type associated with the one or more power ratios.

Clause 3: The method of any one of Clauses 1-2, further comprising: receiving an indication of at least one supported power ratio, wherein the at least one supported power ratio comprises the one or more power ratios.

Clause 4: The method of any one of Clauses 1-3, wherein the first CSF comprises an indication of at least one power ratio of the one or more power ratios.

Clause 5: The method of any one of Clauses 1-4, wherein the signaling indicates an identifier of a machine learning model associated with the one or more power ratios.

Clause 6: The method of any one of Clauses 1-5, wherein each of the one or more power ratios is a ratio of a function of the transmit power to a function of the receive power.

Clause 7: The method of any one of Clauses 1-6, wherein the first CSI-RS is sent within a threshold time period of when the first SRS is received.

Clause 8: The method of any one of Clauses 1-7, wherein the CSF comprises a first channel estimate, and wherein performing channel estimation comprises: determining a second channel estimate based on the first SRS; inputting the first channel estimate and the second channel estimate into a machine learning model; and outputting, from the machine learning model, a third channel estimate.

Clause 9: The method of any one of Clauses 1-7, wherein the CSF comprises a first precoder matrix, and wherein performing channel estimation comprises: determining a first channel estimate based on the first SRS; inputting the first channel estimate and the first precoder matrix into a machine learning model; and outputting, from the machine learning model, a second precoder matrix.

Clause 10: The method of any one of Clauses 1-7, wherein the CSF comprises a first precoder matrix, and wherein performing channel estimation comprises: determining a second precoder matrix based on the first SRS; inputting the first precoder matrix and the second precoder matrix into a machine learning model; and outputting, from the machine learning model, a third precoder matrix.

Clause 11: A method for wireless communications by an apparatus comprising: receiving signaling indicative of one or more power ratios, wherein each of the one or more power ratios is based on a transmit power for transmitting SRS using a corresponding antenna of the apparatus and a receive power for receiving CSI-RS using the corresponding antenna of the apparatus, and wherein the one or more power ratios are associated with one or more antennas of the apparatus; receiving a first CSI-RS using a first antenna of the one or more antennas; sending a first SRS using the first antenna; and sending first CSF corresponding to the CSI-RS.

Clause 12: The method of Clause 11, wherein the signaling indicates a QCL type associated with the one or more power ratios.

Clause 13: The method of any one of Clauses 11-12, further comprising: sending an indication of at least one supported power ratio, wherein the at least one supported power ratio comprises the one or more power ratios.

Clause 14: The method of any one of Clauses 11-13, wherein the first CSF comprises an indication of at least one power ratio of the one or more power ratios.

Clause 15: The method of any one of Clauses 11-14, wherein the signaling indicates an identifier of a machine learning model associated with the one or more power ratios.

Clause 16: The method of any one of Clauses 11-15, wherein each of the one or more power ratios is a ratio of a function of the transmit power to a function of the receive power.

Clause 17: The method of any one of Clauses 11-16, wherein the first CSI-RS is received within a threshold time period of when the first SRS is sent.

Clause 18: The method of any one of Clauses 11-17, further comprising: receiving an identifier of a machine learning model.

Clause 19: The method of Clause 18, further comprising: determining the first CSF based on the CSI-RS and the identifier of the machine learning model.

Clause 20: One or more apparatuses, comprising: one or more memories; and one or more processors configured to cause the one or more apparatuses to perform a method in accordance with any one of clauses 1-19.

Clause 21: One or more apparatuses, comprising means for performing a method in accordance with any one of clauses 1-19.

Clause 22: One or more non-transitory computer-readable media comprising executable instructions that, when executed by one or more processors of one or more apparatuses, cause the one or more apparatuses to perform a method in accordance with any one of clauses 1-19.

Clause 23: One or more computer program products embodied on one or more computer-readable storage media comprising code for performing a method in accordance with any one of clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, the apparatus comprising:
one or more memories; and one or more processors configured to cause the apparatus to:
send signaling indicative of one or more power ratios, wherein each of the one or more power ratios is based on a transmit power for transmitting sounding reference signal (SRS) using a corresponding antenna and a receive power for receiving channel state information reference signal (CSI-RS) using the corresponding antenna, and wherein the one or more power ratios are associated with one or more antennas;
send a first CSI-RS;
receive a first SRS;
receive first channel state feedback (CSF) corresponding to the CSI-RS; and
perform channel estimation based on the first CSF and the first SRS.

2. The apparatus of claim 1, wherein the signaling indicates a quasi-co-location (QCL) type associated with the one or more power ratios.

3. The apparatus of claim 1, wherein the one or more processors are configured to cause the apparatus to:
receive an indication of at least one supported power ratio, wherein the at least one supported power ratio comprises the one or more power ratios.

4. The apparatus of claim 1, wherein the first CSF comprises an indication of at least one power ratio of the one or more power ratios.

5. The apparatus of claim 1, wherein the signaling indicates an identifier of a machine learning model associated with the one or more power ratios.

6. The apparatus of claim 1, wherein each of the one or more power ratios is a ratio of a function of the transmit power to a function of the receive power.

7. The apparatus of claim 1, wherein the first CSI-RS is sent within a threshold time period of when the first SRS is received.

8. The apparatus of claim 1, wherein the CSF comprises a first channel estimate, and wherein, to perform channel estimation, the one or more processors are configured to cause the apparatus to:
determine a second channel estimate based on the first SRS;
input the first channel estimate and the second channel estimate into a machine learning model; and
output, from the machine learning model, a third channel estimate.

9. The apparatus of claim 1, wherein the CSF comprises a first precoder matrix, and wherein, to perform channel estimation, the one or more processors are configured to cause the apparatus to:
determine a first channel estimate based on the first SRS;
input the first channel estimate and the first precoder matrix into a machine learning model; and
output, from the machine learning model, a second precoder matrix.

10. The apparatus of claim 1, wherein the CSF comprises a first precoder matrix, and wherein, to perform channel estimation, the one or more processors are configured to cause the apparatus to:
determine a second precoder matrix based on the first SRS;
input the first precoder matrix and the second precoder matrix into a machine learning model; and
output, from the machine learning model, a third precoder matrix.

11. An apparatus configured for wireless communications, the apparatus comprising: one or more memories; and one or more processors configured to cause the apparatus to:
receive signaling indicative of one or more power ratios, wherein each of the one or more power ratios is based on a transmit power for transmitting sounding reference signal (SRS) using a corresponding antenna of the apparatus and a receive power for receiving channel state information reference signal (CSI-RS) using the corresponding antenna of the apparatus, and wherein the one or more power ratios are associated with one or more antennas of the apparatus;
receive a first CSI-RS using a first antenna of the one or more antennas;
send a first SRS using the first antenna; and
send first channel state feedback (CSF) corresponding to the CSI-RS.

12. The apparatus of claim 11, wherein the signaling indicates a quasi-co-location (QCL) type associated with the one or more power ratios.

13. The apparatus of claim 11, wherein the one or more processors are configured to cause the apparatus to:
send an indication of at least one supported power ratio, wherein the at least one supported power ratio comprises the one or more power ratios.

14. The apparatus of claim 11, wherein the first CSF comprises an indication of at least one power ratio of the one or more power ratios.

15. The apparatus of claim 11, wherein the signaling indicates an identifier of a machine learning model associated with the one or more power ratios.

16. The apparatus of claim 11, wherein each of the one or more power ratios is a ratio of a function of the transmit power to a function of the receive power.

17. The apparatus of claim 11, wherein the first CSI-RS is received within a threshold time period of when the first SRS is sent.

18. The apparatus of claim 11, wherein the one or more processors are configured to cause the apparatus to:
receive an identifier of a machine learning model.

19. The apparatus of claim 18, wherein the one or more processors are configured to cause the apparatus to:
determine the first CSF based on the CSI-RS and the identifier of the machine learning model.

20. A method for wireless communications by an apparatus comprising:
sending signaling indicative of one or more power ratios, wherein each of the one or more power ratios is based on a transmit power for transmitting sounding reference signal (SRS) using a corresponding antenna and a receive power for receiving channel state information reference signal (CSI-RS) using the corresponding antenna, and wherein the one or more power ratios are associated with one or more antennas;
sending a first CSI-RS;
receiving a first SRS;
receiving first channel state feedback (CSF) corresponding to the CSI-RS; and
performing channel estimation based on the first CSF and the first SRS.

21. The method of claim 20, wherein the signaling indicates a quasi-co-location (QCL) type associated with the one or more power ratios.

22. The method of claim 20, further comprising:
receiving an indication of at least one supported power ratio, wherein the at least one supported power ratio comprises the one or more power ratios.

23. The method of claim 20, wherein the first CSF comprises an indication of at least one power ratio of the one or more power ratios.

24. The method of claim 20, wherein the signaling indicates an identifier of a machine learning model associated with the one or more power ratios.

25. The method of claim 20, wherein each of the one or more power ratios is a ratio of a function of the transmit power to a function of the receive power.

26. A method for wireless communications by an apparatus comprising:
receiving signaling indicative of one or more power ratios, wherein each of the one or more power ratios is based on a transmit power for transmitting sounding reference signal (SRS) using a corresponding antenna of the apparatus and a receive power for receiving channel state information reference signal (CSI-RS) using the corresponding antenna of the apparatus, and wherein the one or more power ratios are associated with one or more antennas of the apparatus;
receiving a first CSI-RS using a first antenna of the one or more antennas;
sending a first SRS using the first antenna; and
sending first channel state feedback (CSF) corresponding to the CSI-RS.

27. The method of claim 26, wherein the signaling indicates a quasi-co-location (QCL) type associated with the one or more power ratios.

28. The method of claim 26, further comprising:
sending an indication of at least one supported power ratio, wherein the at least one supported power ratio comprises the one or more power ratios.

29. The method of claim 26, wherein the first CSF comprises an indication of at least one power ratio of the one or more power ratios.

30. The method of claim 26, wherein the signaling indicates an identifier of a machine learning model associated with the one or more power ratios.
